(19) United States
(12) Patent Application Publication
(10) Pub. No.: US 2025/0062310 A1
(43) Pub. Date: Feb. 20, 2025

(54) SILICON-BASED ACTIVE MATERIAL FOR LITHIUM SECONDARY BATTERY AND SECONDARY BATTERY ANODE MATERIAL USING THE SAME

(71) Applicant: KOREA INSTITUTE OF SCIENCE AND TECHNOLOGY, Seoul (KR)

(72) Inventors: Jihyun HONG, Seoul (KR); Minah LEE, Seoul (KR); Jinkwan CHOI, Seoul (KR); Hun-Gi JUNG, Seoul (KR); Dong-Ik KIM, Seoul (KR)

(21) Appl. No.: 18/680,217

(22) Filed: May 31, 2024

(30) Foreign Application Priority Data
Aug. 18, 2023 (KR) 10-2023-0108535

(51) Int. Cl. H01M 4/04; H01M 4/02; H01M 4/485; H01M 4/62

(52) U.S. Cl. CPC H01M 4/0416; H01M 4/0471; H01M 4/485; H01M 4/625; H01M 2004/021; H01M 2004/027

(57) ABSTRACT

Provided are a prelithiation method of a silicon-based active material, the prelithiation method including step S1 of immersing the silicon-based active material in a prelithiation solution including an organic solvent and a lithium-hydrocarbon molecule complex, step S2 of obtaining a powder by washing the silicon-based active material with the organic solvent and drying the silicon-based active material, and step S3 of performing a heat treatment on the powder at a temperature of 400° C. to 800° C. in an inert gas atmosphere, and a silicon-based active material prelithiated by the method.

### CROSS-REFERENCE TO RELATED APPLICATION

This application claims the benefit of Korean Patent Application No. 10-2023-0108535 filed on Aug. 18, 2023, in the Korean Intellectual Property Office, the entire disclosure of which is incorporated herein by reference for all purposes.

### BACKGROUND

### 1. Field of the Invention

One or more embodiments relate to a silicon-based active material for a lithium secondary battery and a secondary battery anode material using the silicon-based active material.

### 2. Description of the Related Art

Lithium secondary batteries have advantages such as a high energy density, a light weight, a high output, stable discharge characteristics, and stability over a wide range of temperatures, and are thus widely used today in small home appliances and precision devices. Recently, the use of medium to large-sized lithium secondary batteries has also increased rapidly. Accordingly, especially in anodes, silicon-based anode materials, which may dramatically increase a capacity compared to commercial graphite anodes, are attracting attention.

However, silicon-based anode materials have difficulty in commercialization because an irreversible capacity in a first cycle, which occurs due to low initial efficiency, limits a reversible capacity during actual battery operation. To solve such a problem, a high-efficiency technology such as a prelithiation method is required.

In methods for prelithiation of silicon-based anode materials reported in the related art, a lithium metal is directly contacted, or a temporary cell is generated, lithium is electrochemically inserted, and electrodes collected by decomposing the cell are used, resulting in high costs and safety issues.

Furthermore, in the prelithiation method of the related art, lithium is inserted into Si and SiO₂ constituting a SiOₓ-based material without distinction to form lithium silicide (LiₓSi) and lithium silicate at the same time. The lithium silicide has poor atmospheric and moisture stability and may cause side reactions with a solvent or water when preparing a slurry, and thus, there may be limitations of the commercialization of active materials.

Accordingly, the present inventors have completed the present disclosure to solve the problems regarding the prelithiation method of the related art as described above.

### SUMMARY

Embodiments provide a prelithiation method of a silicon oxide-based anode material with significantly improved atmospheric and moisture stability by processing a prelithiation solution capable of uniformly inserting lithium to an active material through a spontaneous charge transfer reaction between a lithium-hydrocarbon molecule complex with an oxidation-reduction potential of 0.5 V (vs Li/Li+) or less and a silicon oxide-based (SiOₓ, 0<x<2) anode material, and then performing a heat treatment under suitable conditions, and a silicon-based anode active material that is prelithiated by the above method.

However, goals to be achieved are not limited to those described above, and other goals not mentioned above are clearly understood by one of ordinary skill in the art from the following description.

According to an aspect, there is provided a prelithiation method of a silicon-based active material, the prelithiation method including step S1 of immersing the silicon-based active material in a prelithiation solution including an organic solvent and a lithium-hydrocarbon molecule complex, step S2 of obtaining a powder by washing the silicon-based active material with the organic solvent and drying the silicon-based active material, and step S3 of performing a heat treatment on the powder at a temperature of 400° C. to 800° C. in an inert gas atmosphere.

According to another aspect, there is provided a silicon-based active material prelithiated by the prelithiation method described above, the silicon-based active material including a complex of lithium silicon oxide of Li₂SiO₃ with a size of 12 nanometers (nm) or less and silicon with a size of 5 nm or less.

According to still another aspect, there is provided an anode including the prelithiated silicon-based active material described above, a conductive material, and a binder.

According to still another aspect, there is provided a lithium secondary battery including the anode of described above, a cathode, and an electrolyte.

According to still another aspect, there is provided a capacitor including the anode of described above, a cathode, and an electrolyte.

Additional aspects of embodiments will be set forth in part in the description which follows and, in part, will be apparent from the description, or may be learned by practice of the disclosure.

According to embodiments, in the prelithiation method, safe and uniform lithiation is possible through a solution process, a desired phase may be selectively formed by suppressing growth of silicon crystal grains under relatively low temperature conditions. Therefore, a secondary battery including a prelithiated anode active material has an advantage of being able to exhibit high initial coulombic efficiency and long lifespan. In addition, the active material prelithiated by the prelithiation method described above may exhibit stability in the atmosphere and moisture.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates a schematic diagram of a prelithiation solution and an anode prelithiation technology using the same according to an embodiment;

FIG. 2 is a diagram illustrating a lithium silicon oxide composition through ternary phase equilibrium;

FIG. 3 is a diagram illustrating results of observing X-ray diffraction (XRD) images according to a lithium supply amount;

FIG. 4 is a diagram illustrating electrochemical performance of an electrode according to a supplied amount of lithium;

FIG. 5 is a diagram illustrating dQ/dV analysis according to an embodiment;

FIG. 6 is a diagram illustrating a change in a full width at half maximum (FWHM) on XRD according to a supplied amount of lithium;

FIG. 7 is a diagram illustrating results of calculating crystal sizes of silicon and lithium silicon oxide through XRD results;

FIG. 8 is a diagram illustrating a change in initial coulombic efficiency according to a change in lithium composition;

FIG. 9 is a diagram illustrating lifespan characteristics according to a change in a lithium composition;

FIG. 10 is a diagram illustrating XRD results for lithium silicon oxide phase formation according to a heat treatment temperature;

FIG. 11 is a diagram illustrating a difference in performance according to solvents (THF, 2-meTHF) when treating a solution at room temperature;

FIG. 12 is a diagram illustrating results of evaluating performance when naphthalene is used as a hydrocarbon molecule according to an embodiment;

FIG. 13 is a diagram illustrating selected area diffraction (SAD) pattern analysis using transmission electron microscopy (TEM) for a prelithiated silicon-based active material according to an embodiment;

FIG. 14 is a diagram illustrating a TEM diffraction dark-field (DF) image of (111)Si and (200)Li₂SiO₃ crystal planes for a prelithiated silicon-based active material according to an embodiment;

FIG. 15 is a diagram illustrating results of realizing high coulombic efficiency through optimization of a composition (a ratio of active materials) of an electrode; and

FIG. 16 is a diagram illustrating results of evaluating performance of a graphite/silicon oxide complex anode according to an embodiment.

### DETAILED DESCRIPTION

Hereinafter, embodiments will be described in detail with reference to the accompanying drawings. However, various alterations and modifications may be made to the embodiments and thus, the scope of the disclosure is not limited or restricted to the embodiments. The equivalents should be understood to include all changes, equivalents, and replacements within the idea and the technical scope of the disclosure.

The terminology used herein is for the purpose of describing particular embodiments only and is not to be limiting of the embodiments. The singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

According to an embodiment, there is provided a prelithiation method of a silicon-based active material, the prelithiation method including step S1 of immersing the silicon-based active material in a prelithiation solution including an organic solvent and a lithium-hydrocarbon molecule complex, step S2 of obtaining a powder by washing the silicon-based active material with the organic solvent and drying the silicon-based active material, and step S3 of performing a heat treatment on the powder at a temperature of 400° C. to 800° C. in an inert gas atmosphere.

Silicon-based anode materials have a problem of a large irreversible capacity in a first cycle due to low initial efficiency, and accordingly, the silicon-based active material used in the prelithiation method may include SiOₓ (0<x<2).

The prelithiation method of the silicon-based active material according to an embodiment is performed by immersing the silicon-based active material in a prelithiation solution. Thus, the process is simple, and there is an advantage that lithium may be uniformly inserted into the silicon-based active material through a more uniform reaction, compared to a prelithiation methods such as a solid phase mixing method and the like of the related art. The immersing may be performed, for example, at a temperature of −10° C. to 80° C. Desirably, the immersing may be performed at a temperature of 10° C. to 50° C. In a temperature range of −10° C. to 80° C., an oxidation-reduction potential of the complex typically decreases, and improved reducing power may improve the initial coulombic efficiency. When the immersing is performed at a temperature of lower than −10° C., the oxidation-reduction potential may become too high and a prelithiation reaction may not occur, and when the immersing is performed at a temperature exceeding 80° C., the precipitation of lithium metal may occur, which is not desirable.

The immersing may be performed for 0.01 to 1440 minutes, desirably 1 minute to 600 minutes, and more desirably 5 to 240 minutes. A total mass of lithium ions in the solution may be adjusted from 1 wt % to 18 wt % with respect to the silicon oxide active material, and in order to complete a lithium insertion reaction from the lithium-hydrocarbon molecule complex to silicon oxide, the time may be shortened under high temperature conditions with high reducing power, and the time may be adjusted longer at room temperature and low temperature.

Meanwhile, since the time required for a sufficient reaction may vary depending on a size of active material particles, it is desirable to observe a change in initial efficiency over time and set a reaction time to a point where the initial efficiency no longer improves. In an embodiment, for example, a rapid lithium insertion reaction was induced for 1 hour at a temperature of 60 degrees or higher, and then the temperature was lowered to room temperature to allow the remaining lithium insertion reaction to occur for a sufficient period of time, but it is not limited to this temperature and time.

Meanwhile, the organic solvent used in step S1 may include a cyclic ether-based solvent, a linear ether-based solvent, and the like.

Specific examples of the cyclic ether-based solvent may include one or more selected from a group consisting of tetrahydropyran, dioxolane, methyl dioxolane, dimethyl dioxolane, vinyl dioxolane, methoxy dioxolane, ethyl methyl dioxolane, oxane, dioxane, trioxane, tetrahydrofuran, methyl tetrahydrofuran, dimethyl tetrahydrofuran, dimethoxy tetrahydrofuran, ethoxy tetrahydrofuran, ethyl tetrahydrofuran, methyl tetrahydropyran, dimethyl tetrahydropyran, dihydropyran, tetrahydropyran, hexamethylene oxide, furan, dihydrofuran, dimethoxybenzene, and dimethyloxetane.

In addition, specific examples of the linear ether-based solvent may include one or more selected from a group consisting of dimethyl ether, diethyl ether, ethyl methyl ether, ethyl propyl ether, dipropyl ether, diisopropyl ether, dibutyl ether, diisobutyl ether, ethyl tertbutyl ether, dimethoxymethane, trimethoxymethane, dimethoxyethane, diethoxyethane, dimethoxypropane, diethylene glycol dimethyl ether, diethylene glycol ethyl methyl ether, diethylene glycol isopropyl methyl ether, diethylene glycol butyl methyl ether, diethylene glycol diethyl ether, diethylene glycol tertbutyl ethyl ether, triethylene glycol dimethyl ether, tetraethylene glycol dimethyl ether, ethylene glycol ethylmethyl ether, ethylene glycol divinyl ether, diethylene glycol divinyl ether, triethylene glycol divinyl ether, and methoxypropane.

Among them, considering excellent initial coulombic efficiency in a first cycle of a prelithiated electrode, 2-methyltetrahydrofuran may be considered desirable among the organic solvents.

Meanwhile, the lithium-hydrocarbon complex in step S1 may have an oxidation-reduction potential of 0.5 V or less compared to lithium (vs Li/Li). By having the above oxidation-reduction potential, sufficient reducing power for prelithiation may be exhibited, successful chemical prelithiation is possible even in a complex anode containing a silicon-based active material, and lithium may be inserted uniformly throughout the electrode.

Hydrocarbon molecules of the lithium-hydrocarbon molecule complex may include one or more selected from a group consisting of biphenyl, naphthalene, anthracene, phenanthrene, tetracene, diphenylanthracene, perylene, pyrene, triphenylene, bianthryl, terphenyl, quaterphenyl, and stilbene, and the hydrocarbon molecules may be substituted or unsubstituted with one or more substituents selected from a group consisting of an alkyl group having 1 to 4 carbon atoms, benzene, fluorine, and chlorine.

Step S2 may correspond to step of obtaining a powder by washing the silicon-based active material with the same solvent as the organic solvent used in step S1 and drying the silicon-based active material. Through this, higher-purity prelithiated powder may be obtained.

Then, a heat treatment is performed on the powder obtained in the same manner as above (S3).

The prelithiation method of the related art uses a method of simultaneously forming lithium silicide and lithium silicate by inserting lithium without distinguishing between Si and SiO₂, which constitute the silicon-based active material. The lithium silicide generated accordingly has poor stability in the atmosphere and moisture, and has a problem of causing side reactions with water when preparing a slurry.

Accordingly, in the present disclosure, a complex formed of lithium silicide and lithium silicate may be converted into a complex of silicon and lithium silicate by going through a heat treatment process of step S3, and a high-value and high-performance active material with high initial efficiency, reversible capacity, atmospheric stability, and fairness may be obtained.

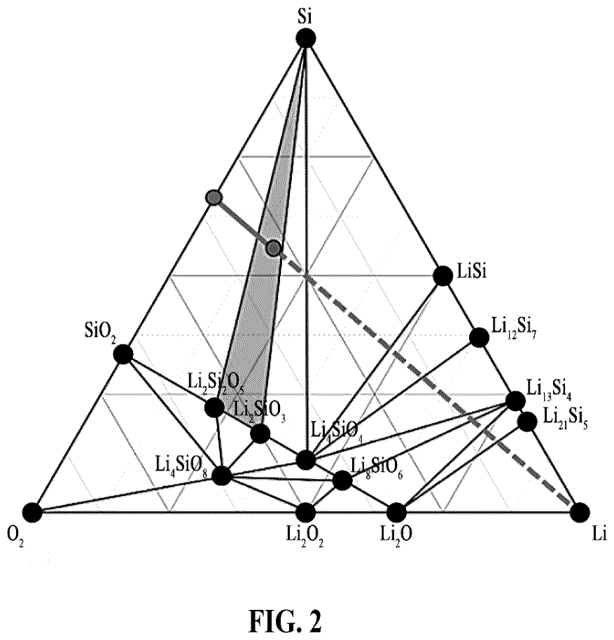

More specifically, taking a case where the silicon-based oxide is silicon oxide SiOₓ (x=1) as an example with reference to FIG. 2, when lithium is inserted into the silicon oxide, a Li composition changes along a central red line at room temperature. Then, when the heat treatment is performed with a specific composition, phase separation occurs into a phase corresponding to a vertex of a corresponding region, making the overall system stable.

Meanwhile, as an example, a material of a green dot, which existed in a state of Li_{y}Si+LizSiO₂ before the heat treatment, is converted to a mixed state of Li₂SiO₃, Li₂Si₂O₅, and Si when the heat treatment is performed.

However, in a case of a compound of a composition containing excessive lithium beyond Li₄SiO₄ in lithium silicon oxide, it may not be applied to an electrode manufacturing process due to reactivity with moisture. Accordingly, only by supplying and heating as much lithium as a solid line area of the central red line may achieve a stable state in which lithium silicon oxide and silicon are mixed. That is, when an appropriate amount of lithium corresponding to a yellow area shown in FIG. 2 is added to silicon oxide SiOₓ (0<x<2), the formation of a lithium silicon oxide/silicon complex stable in the atmosphere and moisture may be induced.

Meanwhile, the heat treatment process in step S3 may be performed under an atmosphere of an inert gas such as nitrogen or argon (Ar) at a temperature range of 400° C. to 800° C. for 0.1 to 12 hours, desirably, at a temperature of 450° C. to 700° C. for 0.5 to 6 hours.

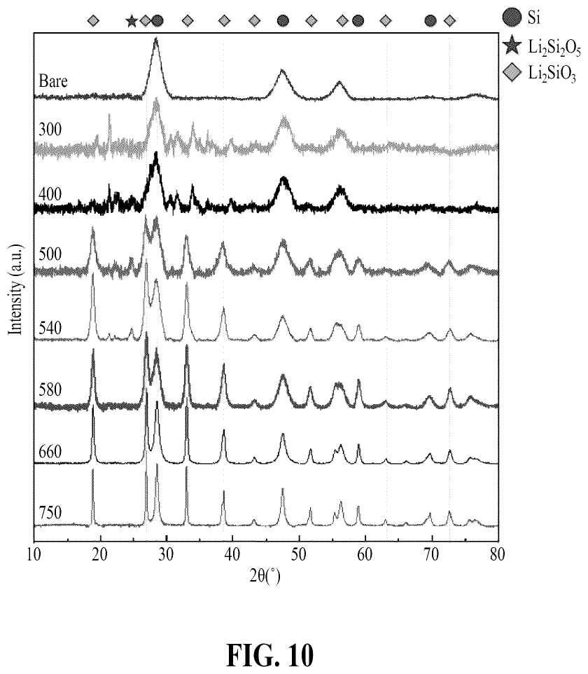

When the heat treatment is performed at a temperature lower than 400° C., as shown in FIG. 10, even when the same amount of lithium is supplied, the formation of a Li₂SiO₃ phase is limited, and the Li₂SiO₃ phase may be mainly formed along with a Si phase at a temperature of 500° C. or higher. In other words, in order to form the Li₂SiO₃ phase showing high initial coulombic efficiency, the heat treatment at an appropriate temperature or higher is required after the prelithiation.

Meanwhile, from a viewpoint of the heat treatment process S3 as described above, a lithium content of the lithium-hydrocarbon molecule complex may be 5 mass % to 15 mass %, more desirably 5 mass % to 12.5 mass %, and even more desirably 6.5 mass % to 12.5 mass % with respect to the mass of the silicon-based active material.

As shown in FIG. 2, after the heat treatment, depending on the amount of lithium supplied, Li₂Si₂O₅, Li₂SiO₃, and Li₄SiO₄ phases are formed together with the silicon phase.

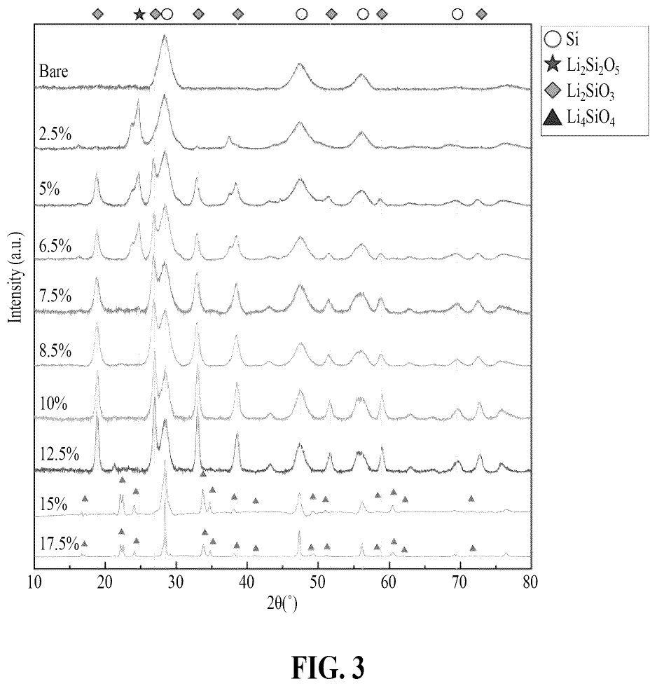

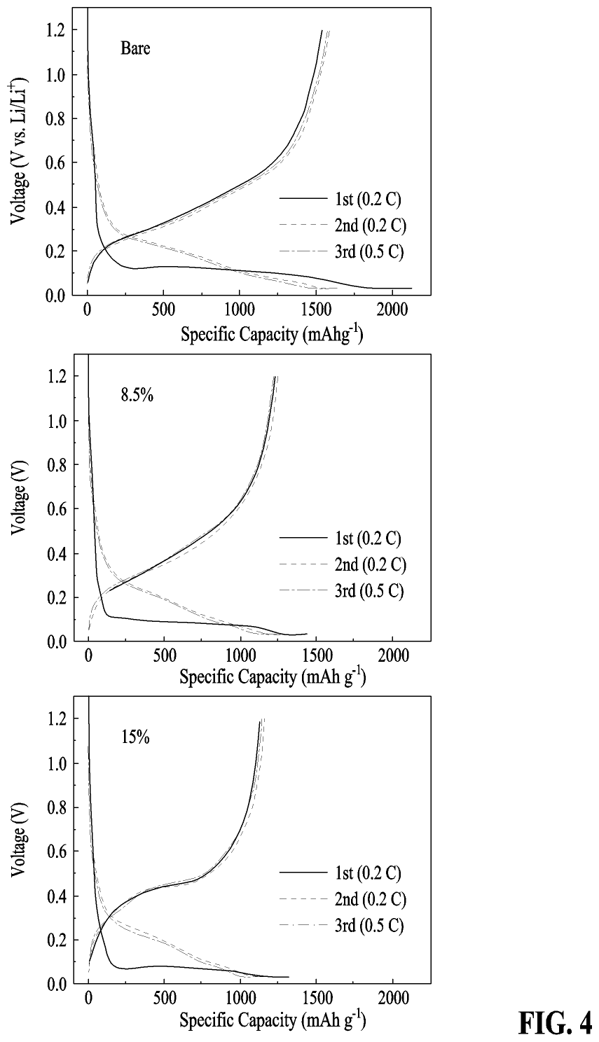

In particular, as shown in FIG. 3, when the amount of lithium is 5 mass % or more and 12.5 mass % or less with respect to the mass of the silicon-based active material, it is found that, not only unstable Li₄SiO₄ is not formed in the atmosphere, and also a size of a peak (25°) of a low-efficiency Li₂Si₂O₅ phase is formed to be relatively smaller than a size of a peak (27°) of Li₂SiO₃ phase. In contrast, when the amount of lithium is 2.5 mass %, it is found that the size of the peak (25°) of the low-efficiency Li₂Si₂O₅ phase is formed to be relatively larger than the size of the peak (27°) of Li₂SiO₃ phase. In addition, when the amount of lithium supplied is excessive, the crystallinity of silicon is strengthened, causing an increase in the size of crystal grains, and as shown with a graph of 15 mass % of FIG. 4, a flat section appears on a charge/discharge graph (capacity/voltage), indicating a decrease in capacity and lifespan characteristics.

According to an embodiment, a prelithiated silicon-based active material including a complex of lithium silicon oxide of Li₂SiO₃ with a size of 12 nm or less and silicon with a size of 5 nm or less is provided.

Desirably, a particle size of the lithium silicon oxide of Li₂SiO₃ may be 10 nm or less, and a particle size of silicon may be 5 nm or less. When the particle size exceeds the above range, a reversible capacity and lifespan characteristics may deteriorate.

Meanwhile, the complex may further selectively include Li₂Si₂O₅, in addition to Li₂SiO₃ as the lithium silicon oxide, and may desirably include Li₂Si₂O₅ in a smaller amount than Li₂SiO₃.

According to an embodiment, an anode including the silicon-based active material prelithiated by the prelithiation method described above, a conductive material, and a binder may be prepared, and a lithium secondary battery including the anode prepared as described above, a cathode, and an electrolyte may be provided.

In this case, a proportion of the silicon-based active material may be 70 weight % or more with respect to a total weight of the active material, the conductive material, and the binder that constitute the anode.

In addition, the prelithiated silicon-based active material may include amorphous carbon, hard carbon, soft carbon, (in the form of SiOₓ/C; SiOₓ—C or SiOₓ@C; the SiOₓ/C or SiOₓ—C form may refer to simple mixing, complex formation, or carbon-coated form, and the SiOₓ@C form may refer to a carbon-coated form), or graphite, in addition to the silicon complex including lithium silicon oxide and silicon. At this time, a content ratio of graphite to the silicon complex is not greatly limited, however, as an example, the content ratio may be 95:5 to 5:95, and a content of the silicon complex with respect to the total weight of the active material may be, for example, about 5 weight % to about 50 weight %, desirably 5 weight % to 30 weight %. Furthermore, additional examples of the silicon-based active material may be a silicon-based active material in a form in which magnesium (Mg) is additionally included (Mg—SiOₓ, Mg-doped SiOₓ, Mg—SiOₓ/C, Mg-doped SiOₓ/C, Mg—SiOₓ—C, or Mg-doped SiOₓ—C).

When the silicon-based active material is the silicon-based active material in the form of Mg-SiOₓ or Mg—SiOₓ/C, a content of Mg included therein may be 13 weight % or less with respect to the total weight of the active material.

Hereinafter, the configuration of the present disclosure and its effects will be described in more detail through examples and comparative examples. However, the examples are for describing the present disclosure in more detail, and the scope of the present disclosure is not limited to these examples.

### Examples

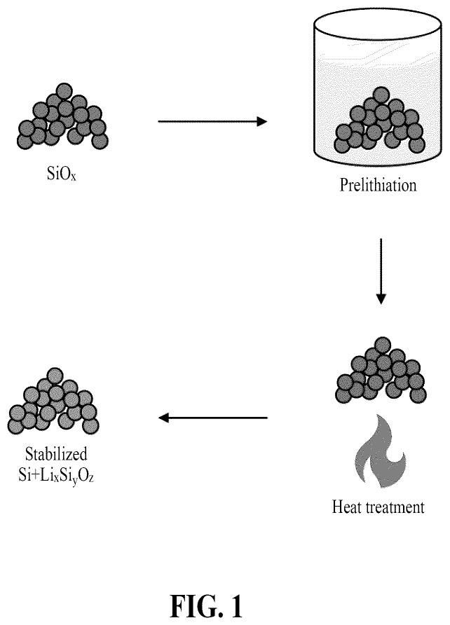

### 1. Preparation Example: Preparation of Prelithiation Solution and Prelithiation Method (FIG. 1)

A 2-methyltetrahydrofuran (2-meTHF) solution in which 1M aromatic hydrocarbon (biphenyl) and lithium ions are dissolved was prepared, and silicon oxide (SiOₓ, 0<x<2) was immersed in the solution and lithiated. Through this, lithium was simultaneously inserted into Si and SiO₂ domains constituting the SiOₓ and converted into a complex of lithium silicide and lithium silicate.

A lithiated silicon oxide complex powder was collected from the solution and washed with 2-meTHF solvent to remove residual lithium and biphenyl.

Then, the heat treatment was performed by heating the lithiated powder in an argon atmosphere at 400° C. to 800° C. for 0.5 to 6 hours, and a stabilized powder in the form of a silicon and lithium silicate complex was obtained.

### 2. Test Example 1: Observation of X-Ray Diffraction (XRD) Image According to Lithium Supply Amount (FIG. 3)

The prelithiation was performed by immersing a silicon oxide (SiOₓ) active material in a 2-methyltetrahydrofuran-based 1M biphenyl-lithium solution containing 2.5 to 17.5 mass % of lithium.

Then, the powder obtained by washing with the same solvent was heated in the argon atmosphere and then subjected to the XRD analysis.

As a result, after a raw material where only a silicon (Si) phase with low crystallinity existed is prelithiated and heated, Li₂Si₂O₅, Li₂SiO₃, and Li₄SiO₄ phases were observed together with the silicon phase depending on the amount of lithium supplied, and it was confirmed that an intensity of a peak of the silicon phase increased and became stronger as the supply of lithium increased.

Through this, in a case where the amount of lithium is 7.5 mass % or more and 12.5 mass % or less, it was found that the unstable Li₄SiO₄ phase was not formed in the atmosphere and the low-efficiency Li₂Si₂O₅ phase was not formed, making it a suitable section for high efficiency.

In addition, it was found that, as the amount of lithium supplied increases, the crystallinity of silicon is strengthened, thereby increasing the size of the crystal grains, and it was confirmed that this may affect electrochemical properties.

### 3. Test Example 2: Evaluation of Electrochemical Performance of Electrode According to Lithium Supply Amount (FIG. 4)

The prelithiation was performed by immersing a silicon oxide (SiOₓ) active material in a 2-methyltetrahydrofuran-based 1M biphenyl-lithium solution containing 2.5 to 17.5 mass % of lithium. Then, the powder obtained by washing with the same solvent was heated in the argon atmosphere and an electrode was manufactured with the powder obtained therefrom.

A lithiated silicon oxide electrode was punched to have a diameter of 11.3 mm to use it as an anode, a lithium metal chip was punched to have a diameter of 16 mm to use it as a cathode, celgard was used as a separator, and an electrolyte including 5 volume % of an FEC additive in 1 M LiPF₆ EC/DEC was used to manufacture a CR2032 type battery. The battery was charged and discharged at a current density of 0.2 C in a range of a lower discharging voltage of 30 mV and an upper charging voltage of 1.2 V at room temperature of 30° C. to evaluate initial coulombic efficiency and a capacity.

As a result, a control bare silicon oxide electrode showed initial efficiency of 72.0%, while electrodes supplied with 8.5 mass % and 15 mass % of lithium showed initial coulombic efficiencies of 84.9% and 85.8%, respectively, and it was confirmed that the initial coulombic efficiency increased as the lithium supply increased.

However, it was confirmed that a flat section appears in an electrochemical profile when 15 mass % of lithium is supplied, which indicates the growth of Si crystal grain size, which leads to a decrease in capacity and lifespan characteristics.

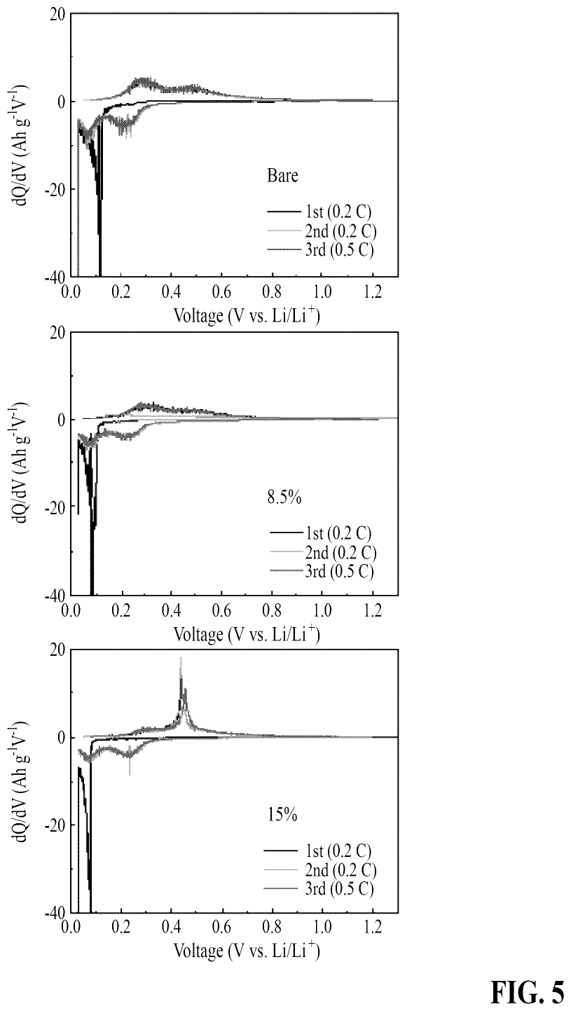

### 4. Test Example 3: dQ/dV Analysis Experiment (FIG. 5)

dQ/dV analysis was performed by differentiating a voltage vs capacity curve in Test Example 2.

As a result, as shown in FIG. 5, while an electrode prepared with Bare and 8.5 mass % of a sample did not show a peak during the charging process, when a lithium composition of the silicon oxide was 15 mass %, a peak of discharge that was not observed at a lower composition was observed and it was confirmed that the crystallinity of silicon had increased.

When a flat voltage occurs, an area with a low gradient on a voltage curve appears as a peak on the dQ/dV curve, and therefore, the observation of the peak may correspond to a phenomenon that has to be avoided when developing a silicon-based electrode.

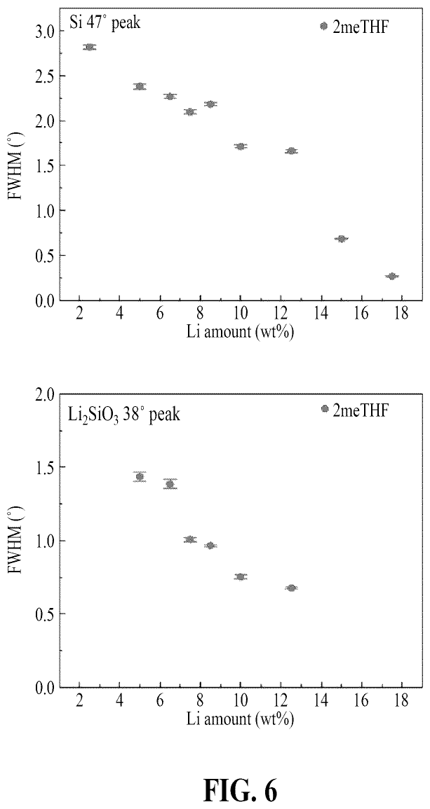

### 5. Test Example 4: Experiment to Confirm Change in Full Width at Half Maximum (FWHM) of XRD Image According to Lithium Supply Amount (FIG. 6)

A final powder was obtained in the same manner as in Test Example 2, and the XRD analysis was performed using this.

As a result of measuring the FWHM of a peak at 470 of the silicon (Si) phase and a peak observed at 380 of the lithium silicon oxide (Li2SiO₃) phase observed in the XRD analysis results using the Lorentzian method, it was confirmed that the FWHM tended to decrease with the increase in lithium supply amount.

As the FWHM of both the silicon phase and the lithium silicon oxide phase tended to decrease with the increase in lithium supply amount, it was expected that the crystallinity of each phase was strengthened and the size of the crystal grains increased.

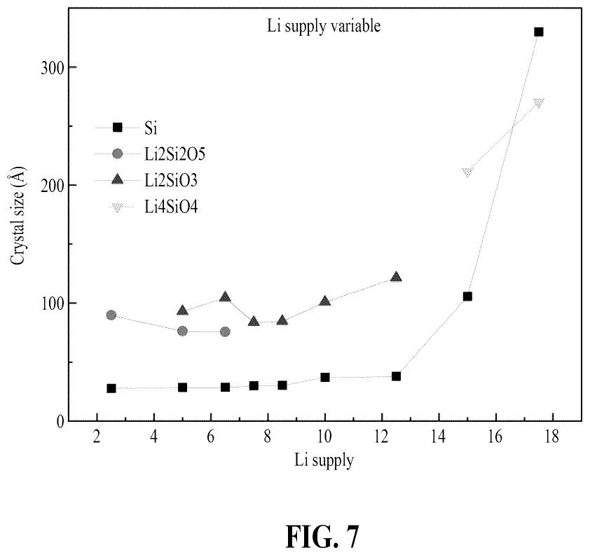

### 6. Test Example 5: Calculation of Crystal Size of Silicon and Lithium Silicon Oxide Through XRD Results (FIG. 7)

A final powder was obtained in the same manner as in Test Example 2, and the XRD analysis was performed using this.

From the XRD results, the size of grains with each phase was calculated based on the FWHM of the peak for each phase.

As the lithium supply amount increased, a lithium silicon oxide phase with a high lithium content was gradually observed, and a silicon phase was continuously observed. The crystal size of the lithium silicon oxide phase gradually increased and then increased sharply after 15 mass %. The silicon phase crystals maintained a similar size up to 12.5 mass %, and the crystal size rapidly grew to 100 Å or more after 15 mass %.

Through this, it was confirmed that the most appropriate upper limit of lithium supply amount is less than 15 mass %.

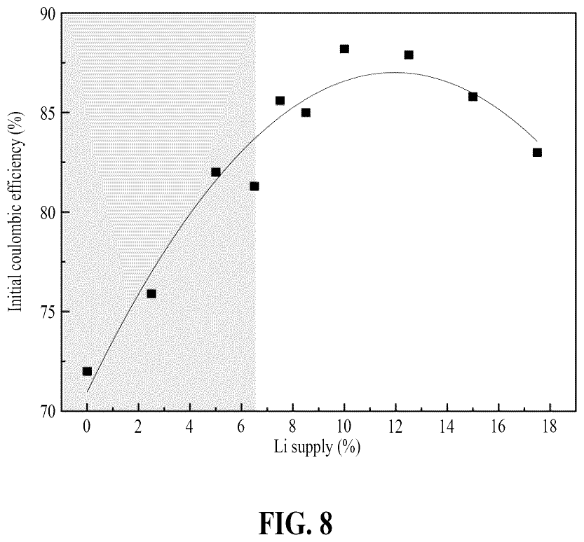

### 7. Test Example 6: Experiment to Confirm Change in Initial Coulombic Efficiency According to Change in Lithium Composition (FIG. 8)

An electrode was manufactured in the same manner as in Test Example 2, and the maximum coulombic efficiency was evaluated when an electrode composition was adjusted.

As a result, as shown in FIG. 8, it was confirmed that the initial coulombic efficiency increased as the lithium composition gradually increased in the raw silicon oxide, and decreased again at 15 mass % or more. Through this, it was confirmed that, in order to secure high initial coulombic efficiency of about 85% or more, lithium needs to be supplied in an amount of desirably 6.5 mass % or more and less than 15 mass %.

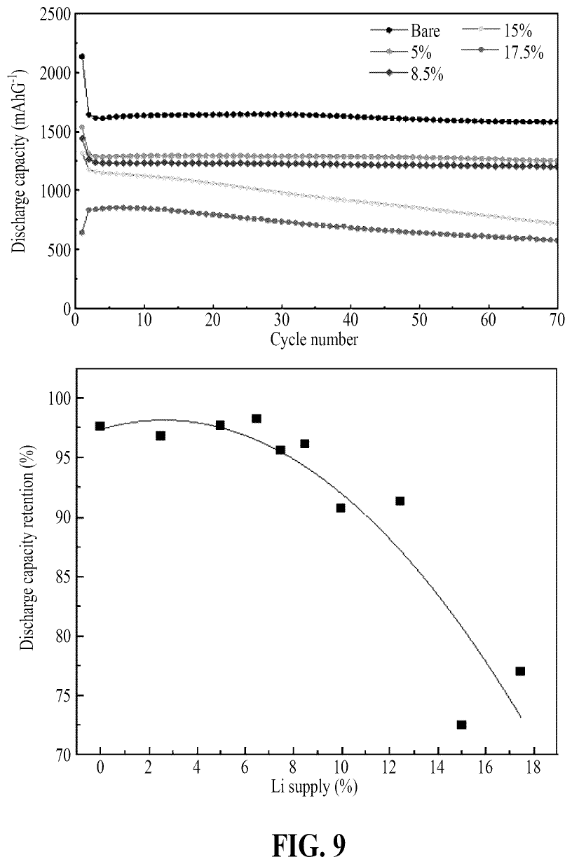

### 8. Test Example 7: Experiment to Confirm Lifespan Characteristics According to Change in Lithium Composition (FIG. 9)

An electrode was manufactured in the same manner as in Test Example 2, and the lifespan characteristics were evaluated when an electrode composition was adjusted.

As a result, as shown in FIG. 9, it was confirmed that the capacity of the active material was the largest and the lifespan was excellent when no prelithiation treatment was performed. When the amount of lithium supplied was 8.5 mass % or less, the initial reversible capacity was partially reduced, but it was confirmed that the lifespan characteristics were maintained excellently. However, when the amount of lithium supplied was 15 mass % or more, it was confirmed that both lifespan characteristics and the reversible capacity rapidly decreased. Through this, it was found that, in order to improve initial efficiency and secure excellent lifespan characteristics, it is necessary to supply lithium in an amount of desirably less than 15 mass %.

### 9. Test Example 8: Experiment to Confirm Formation of Lithium Silicon Oxide Phase According to Heat Treatment Temperature (FIG. 10)

The prelithiation was performed by immersing a silicon oxide (SiOₓ) active material in a 2-methyltetrahydrofuran-based 1M biphenyl-lithium solution containing 10 mass % of lithium. Then, a powder obtained by washing with the same solvent was heated in the argon atmosphere at different heat treatment temperatures, and XRD analysis was performed on the powder obtained therefrom.

As a result, as shown in FIG. 10, when the heat treatment was performed at a temperature of 400° C. or lower, the Li₂SiO₃ phase was not formed even though the same amount of lithium was supplied. The Li₂SiO₃ phase was observed along with the Si phase from temperatures of 500° C. or higher.

Through this, it was confirmed that, in order to form the Li₂SiO₃ phase showing high initial coulombic efficiency, the heat treatment at a predetermined temperature or higher is necessary after the prelithiation.

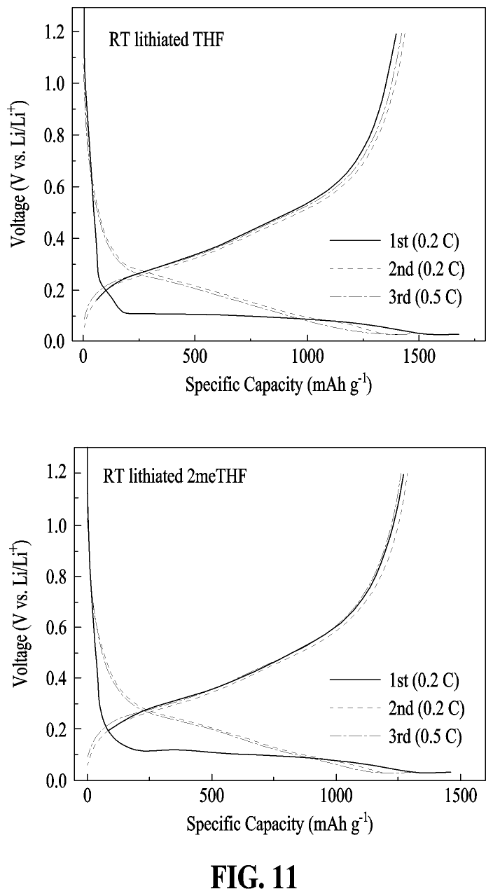

### 10. Test Example 9: Experiment to Confirm Performance Difference According to Solvent when Processing Solution at Room Temperature (FIG. 11)

The prelithiation was performed by immersing a silicon oxide (SiOₓ) active material in a 2-methyltetrahydrofuran-based 1M biphenyl-lithium solution containing 8.5 mass % of lithium. Then, a powder obtained by washing with the same solvent was heated in the argon atmosphere, and an electrode was manufactured from the powder obtained therefrom.

A lithiated silicon oxide electrode was punched to have a diameter of 11.3 mm to use it as an anode, a lithium metal chip was punched to have a diameter of 16 mm to use it as a cathode, celgard was used as a separator, and an electrolyte including 5 volume % of an FEC additive in 1 M LiPF₆ EC/DEC was used to manufacture a CR2032 type battery. The battery was charged and discharged at a current density of 0.2 C in a range of a lower discharging voltage of 30 mV and an upper charging voltage of 1.2 V at room temperature of 30° C. to evaluate initial coulombic efficiency and a capacity.

Then, the same experiment was conducted with the type of solvent changed to tetrahydrofuran.

As a result, when the treatment is performed with a tetrahydrofuran solution in a first cycle of the prelithiated silicon oxide mixed electrode, the initial coulombic efficiency of 83.2% was obtained, and when it treated with a 2-methyltetrahydrofuran solution, the initial coulombic efficiency of 86.5% was obtained. When 2-methyltetrahydrofuran is used in the same amount of solution, higher efficiency may be obtained compared to when the tetrahydrofuran solution is used, and it was confirmed that, even when all conditions except the type of solution were the same, there was a difference in performance after treatment. It is understood that this is because an oxidation/reduction potential of lithium-biphenyl (Li-BP) in the tetrahydrofuran solution is higher than an oxidation/reduction potential of lithium-biphenyl (Li-BP) in the 2-methyltetrahydrofuran solution, thereby reducing a driving force of lithium insertion. Accordingly, it is found that it is desirable to use 2-methyltetrahydrofuran as a solvent in order to sufficiently insert the lithium in the prelithiation solution into the silicon-based active material.

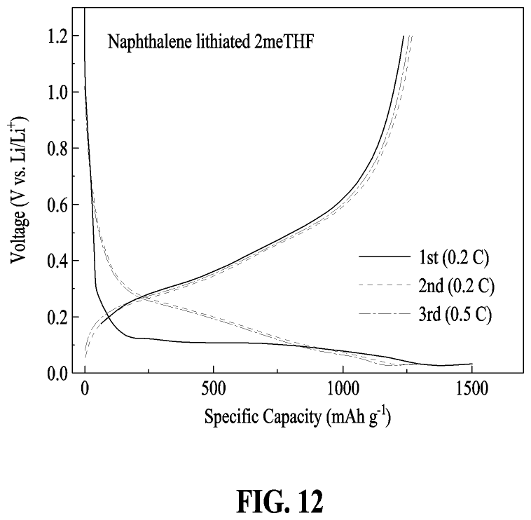

### 11. Test Example 10: Experiment to Confirm Naphthalene Titration (FIG. 12)

The prelithiation was performed by immersing a silicon oxide (SiOₓ) active material in a 2-methyltetrahydrofuran-based 1M lithium-naphthalene solution containing 3.5 mass % of lithium. Then, the powder obtained by washing with the same solvent was heated in the argon atmosphere, and an electrode was manufactured from the powder obtained therefrom.

A lithiated silicon oxide electrode was punched to have a diameter of 11.3 mm to use it as an anode, a lithium metal chip was punched to have a diameter of 16 mm to use it as a cathode, celgard was used as a separator, and an electrolyte including 5 volume % of an FEC additive in 1 M LiPF₆ EC/DEC was used to manufacture a CR2032 type battery. The battery was charged and discharged at a current density of 0.2 C, 0.5 C in a range of a lower discharging voltage of 30 mV and an upper charging voltage of 1.2 V at room temperature of 30° C. to evaluate initial coulombic efficiency and a capacity.

As a result, as shown in FIG. 12, the reversible capacity of 1237 mAh·g⁻¹ and improved coulombic efficiency of 82.3% were shown in a first cycle of the silicon oxide mixed electrode treated with a naphthalene-based prelithiation solution. From this, it was confirmed that not only biphenyl but also other redox molecules may be used for the prelithiation of silicon oxide.

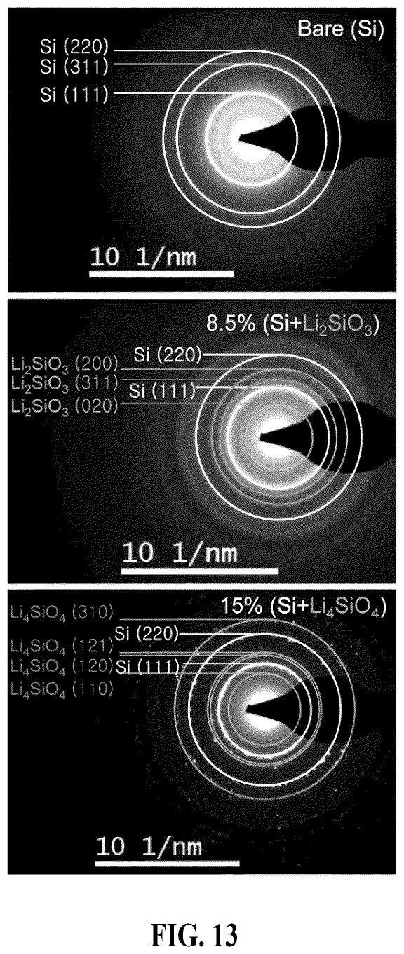

### 12. Test Example 11: Experiment to Confirm Transmission Electron Microscopy (TEM) Selected Area Diffraction (SAD) Pattern (FIG. 13)

The prelithiation was performed by immersing a silicon oxide (SiOₓ) active material in each of 2-methyltetrahydrofuran-based 1M biphenyl-lithium solutions containing 8.5 mass % and 15 mass % of lithium. Then, the powder obtained by washing with the same solvent was heated in the argon atmosphere, the powder obtained therefrom and a raw powder without treatment were analyzed using a TEM.

An interplanar distance of a concentric circle shown through SAD analysis was measured, and a phase existing in each sample was confirmed by comparing it with the lithium silicon oxide phase that may exist.

As a result, a silicon (Si) phase was observed in the raw sample, Li₂SiO₃ and Li₄SiO₄ phases were observed along with the silicon phase, respectively, in a lithium silicon oxide sample prepared by supplying 8.5 mass % and 15 mass % of lithium, and accordingly, it was confirmed that a phase corresponding to the phase identified through the XRD analysis exists.

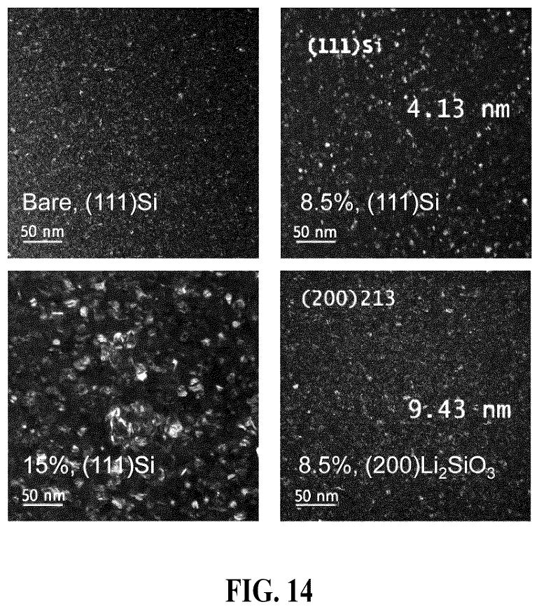

### 13. Test Example 12: TEM Diffraction Dark-Field (DF) Image (FIG. 14)

The prelithiation was performed by immersing a silicon oxide (SiOₓ) active material in each of 2-methyltetrahydrofuran-based 1M biphenyl-lithium solutions containing 8.5 mass % and 15 mass % of lithium. Then, the powder obtained by washing with the same solvent was heated in the argon atmosphere, the powder obtained therefrom and a raw powder without treatment were analyzed using a TEM.

After obtaining an overall SAD pattern of the material, the remainder except a diffraction ring corresponding to a specific crystal plane was masked to show only a unique crystal plane of each target crystal phase as a DF image, and through this, a crystal grain size of the phase was confirmed.

In a case of the silicon phase based on a (111) crystal plane, the size of the crystal grains gradually increased from the raw material to the 8.5 mass % and 15 mass % samples, and the results corresponded to what was expected through XRD analysis. It was confirmed that the size of crystal grains of the 15 mass % lithiated sample was excessively large, resulting in poor electrochemical performance.

In a case of the Li₂SiO₃ phase based on a (200) crystal plane, it was confirmed that the size of the crystal grains observed in the 8.5 mass % sample was 9.43 nm, a value similar to the XRD results.

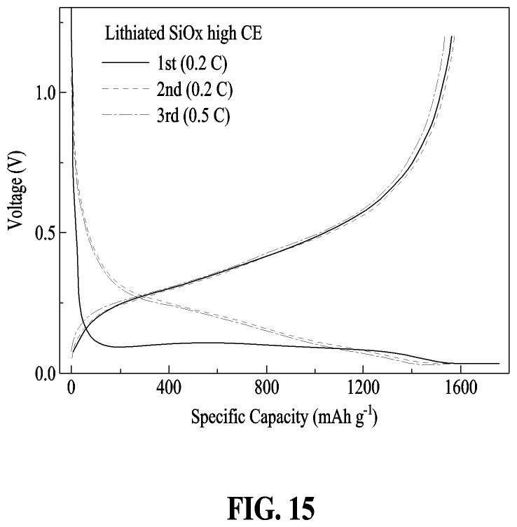

### 14. Test Example 13: Experiment to Confirm Implementation of High Coulombic Efficiency by Adjusting Electrode Composition (FIG. 15)

The prelithiation was performed by immersing a silicon oxide (SiOₓ) active material in a 2-methyltetrahydrofuran-based 1M biphenyl-lithium solution containing 8.5 mass % of lithium. Then, a powder obtained by washing with the same solvent was heated in the argon atmosphere, and an electrode having a ratio of an active material, a conductive material, and a binder of 90:5:5 as a weight ratio was manufactured using the powder obtained therefrom.

A lithiated silicon oxide electrode was punched to have a diameter of 11.3 mm to use it as an anode, a lithium metal chip was punched to have a diameter of 16 mm to use it as a cathode, celgard was used as a separator, and an electrolyte including 5 volume % of an FEC additive in 1 M LiPF₆ EC/DEC was used to manufacture a CR2032 type battery. The battery was charged and discharged at a current density of 0.2 C in a range of a lower discharging voltage of 30 mV and an upper charging voltage of 1.2 V at room temperature of 30° C. to evaluate maximum coulombic efficiency when an electrode composition was adjusted.

As a result, the reversible capacity of 1564 mAh·g⁻¹ and coulombic efficiency of 89.0% were shown in a first cycle of the prelithiated silicon oxide mixed electrode, and when a proportion of the active material was increased to 90%, it was confirmed that higher coulombic efficiency was observed than under existing conditions (a ratio of the active material, conductive material, binder of 70:18:12).

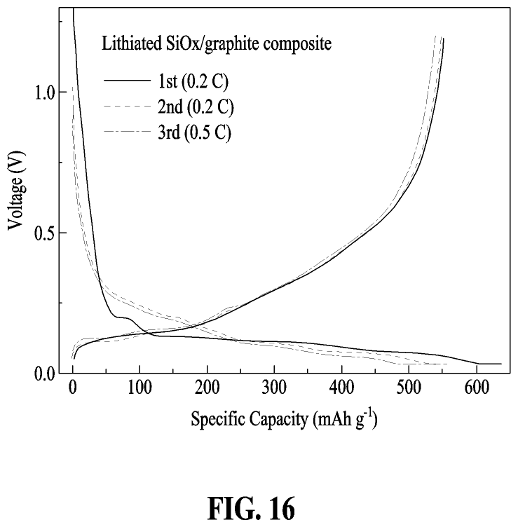

### 15. Test Example 14: Evaluation of Graphite/Silicon Oxide Complex Anode Performance (FIG. 16)

The prelithiation was performed by immersing a silicon oxide (SiOₓ) active material in a 2-methyltetrahydrofuran-based 1M biphenyl-lithium solution containing 8.5 mass % of lithium. Then, a powder obtained by washing with the same solvent was heated in the argon atmosphere, and an electrode having a ratio of an active material containing graphite and silicon oxide with a weight ratio of 2:1, a conductive material, and a binder of 92:4:4 as a weight ratio was manufactured using the powder obtained therefrom.

A lithiated silicon oxide electrode was punched to have a diameter of 11.3 mm to use it as an anode, a lithium metal chip was punched to have a diameter of 16 mm to use it as a cathode, celgard was used as a separator, and an electrolyte including 5 volume % of an FEC additive in 1 M LiPF₆ EC/DEC was used to manufacture a CR2032 type battery. The battery was charged and discharged at a current density of 0.2 C in a range of a lower discharging voltage of 30 mV and an upper charging voltage of 1.2 V at room temperature of 30° C. to evaluate coulombic efficiency according to additional complexation with graphite.

The reversible capacity of 552 mAh·g⁻¹ and coulombic efficiency of 86.5% were shown in a first cycle of the graphite/lithiated silicon oxide mixed electrode, and when silicon oxide was prelithiated and stabilized, it was confirmed that an electrode manufactured with a slurry mixed with graphite operated successfully.

As described above, although the embodiments have been described with reference to the limited drawings, a person skilled in the art may apply various technical modifications and variations based thereon. For example, suitable results may be achieved if the described techniques are performed in a different order, and/or if the described components are combined in a different manner, or replaced or supplemented by other components or their equivalents.

Therefore, other implementations, other embodiments, and equivalents of the claims are within the scope of the following claims.

What is claimed is:

1. An prelithiation method of a silicon-based active material, the prelithiation method comprising:
step S1 of immersing the silicon-based active material in a prelithiation solution comprising an organic solvent and a lithium-hydrocarbon molecule complex;
step S2 of obtaining a powder by washing the silicon-based active material with the organic solvent and drying the silicon-based active material; and
step S3 of performing a heat treatment on the powder at a temperature of 400° C. to 800° C. in an inert gas atmosphere.

2. The prelithiation method of claim 1, wherein a lithium content of the lithium-hydrocarbon molecule complex is 5 to 15 mass % with respect to a mass of the silicon-based active material.

3. The prelithiation method of claim 1, wherein the silicon-based active material in step S1 is SiOₓ (0<x<2).

4. The prelithiation method of claim 1, wherein the organic solvent comprises one or more of a cyclic ether-based solvent and a linear ether-based solvent.

5. The prelithiation method of claim 4, wherein the cyclic ether-based solvent comprises one or more selected from a group consisting of tetrahydropyran, dioxolane, methyl dioxolane, dimethyl dioxolane, vinyl dioxolane, methoxy dioxolane, ethyl methyl dioxolane, oxane, dioxane, trioxane, tetrahydrofuran, methyl tetrahydrofuran, dimethyl tetrahydrofuran, dimethoxy tetrahydrofuran, ethoxy tetrahydrofuran, ethyl tetrahydrofuran, methyl tetrahydropyran, dimethyl tetrahydropyran, dihydropyran, tetrahydropyran, hexamethylene oxide, furan, dihydrofuran, dimethoxybenzene, and dimethyloxetane.

6. The prelithiation method of claim 4, wherein the linear ether-based solvent comprises one or more selected from a group consisting of dimethyl ether, diethyl ether, ethyl methyl ether, ethyl propyl ether, dipropyl ether, diisopropyl ether, dibutyl ether, diisobutyl ether, ethyl tertbutyl ether, dimethoxymethane, trimethoxymethane, dimethoxyethane, diethoxyethane, dimethoxypropane, diethylene glycol dimethyl ether, diethylene glycol ethyl methyl ether, diethylene glycol isopropyl methyl ether, diethylene glycol butyl methyl ether, diethylene glycol diethyl ether, diethylene glycol tertbutyl ethyl ether, triethylene glycol dimethyl ether, tetraethylene glycol dimethyl ether, ethylene glycol ethylmethyl ether, ethylene glycol divinyl ether, diethylene glycol divinyl ether, triethylene glycol divinyl ether, and methoxypropane.

7. The prelithiation method of claim 1, wherein the organic solvent comprises 2-methyltetrahydrofuran.

8. The prelithiation method of claim 1, wherein the lithium-hydrocarbon molecule complex has an oxidation-reduction potential of 0.5 V or less with respect to lithium.

9. The prelithiation method of claim 1, wherein
hydrocarbon molecules of the lithium-hydrocarbon molecule complex comprise biphenyl, naphthalene, anthracene, phenanthrene, tetracene, diphenylanthracene, perylene, pyrene, triphenylene, bianthryl, terphenyl, quaterphenyl, and stilbene, and
the hydrocarbon molecules are substituted or unsubstituted with one or more substituents selected from a group consisting of an alkyl group having 1 to 4 carbon atoms, benzene, fluorine, and chlorine.

10. The prelithiation method of claim 1, wherein the heat treatment is performed in step S3 at a temperature equal to or higher than 450° C. and equal to or lower than 700° C.

11. A silicon-based active material prelithiated by the prelithiation method of claim 1, the silicon-based active material comprising:
a complex of lithium silicon oxide of Li₂SiO₃ with a size of 12 nanometers (nm) or less and silicon with a size of 5 nm or less.

12. The silicon-based active material of claim 11, wherein the complex further comprises lithium silicon oxide of Li₂Si₂O₅ with a size of 10 nm or less, and a content of Li₂Si₂O₅ is less than a content of Li₂SiO₃.

13. An anode comprising:
the prelithiated silicon-based active material of claim 11;
a conductive material; and
a binder.

14. The anode of claim 13, wherein a percentage of the prelithiated silicon-based active material is 70 weight % or more with respect to a total weight of the active material, the conductive material, and the binder constituting the anode.

15. The anode of claim 13, wherein the prelithiated silicon-based active material further comprises one or more of graphite, amorphous carbon, hard carbon, soft carbon, and magnesium.

16. The anode of claim 15, wherein a weight ratio of graphite to a silicon complex in the active material is 95:5 to 5:95.
